(19) United States
(12) Patent Application Publication
(10) Pub. No.: US 2009/0119095 A1
(43) Pub. Date: May 7, 2009

(54) Machine Learning Systems and Methods for Improved Natural Language Processing

(75) Inventors: Marlene Beggelman, Cambridge, MA (US); Yuri Smychkovich, North Andover, MA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Enhanced Medical Decisions. Inc., Cambridge, MA (US)

(21) Appl. No.: 12/264,668

(22) Filed: Nov. 4, 2008

Related U.S. Application Data
(60) Provisional application No. 60/985,402, filed on Nov. 5, 2007.

(51) Int. Cl. G06F 17/20; G10L 21/00

(52) U.S. Cl. 704/9; 704/270; 704/E17.001

(57) ABSTRACT

Disclosed is a method to generate at least one new set of concepts to be used to perform natural language processing (NLP) on data. The method includes receiving one or more sources of input data, and determining, based on the one or more sources of input data and on at least one initial set of concepts, at least one attribute representative of a type of information detail to be included in the at least one new set of concepts.

### CROSS-REFERENCE TO RELATED APPLICATIONS

This application claims priority to provisional U.S. application Ser. No. 60/985,402, entitled “Machine Learning, and Artificial Intelligence Technology,” filed Nov. 5, 2007, the content of which is hereby incorporated by reference in its entirety.

### BACKGROUND

Natural language processing (NLP) is applied to data sources to process human language for meaning (semantics) and structure (syntax). It further differentiates meaning of words/phrases and larger text units based on the surrounding semantic context (pragmatics). Syntactical processors assign or “parse” units of text to grammatical categories or “part-of-speech” (noun, verb, preposition, etc.). Semantic processors assign units of text to lexicon classes to standardize the representation of meaning. Text communications are said to be “tokenized” when discrete units of text are classified according to their semantic and syntactical categories. Some approaches for NLP rely on classifiers, also referred to as ontologies, which are sets of concepts (e.g., abstract concepts) that are used to parse, or otherwise analyze input data sources.

### SUMMARY

Systems and methods for providing improved natural-language based data processing and classification (e.g., improved processing of medical data to enable improved medical decision making operations) apply natural language processing (NLP) and knowledge representation (KR) approaches that differs from other existing methodologies. A principal function of the natural language processor described herein, developed by Enhanced Medical Decisions, Inc. (EMD) is to recognize the presence of predefined concepts and more complex knowledge/information that reference these concepts in the corpus of free and structured text within the medical domain.

In some embodiments, the systems described herein include a machine learning (ML) engine configured to receive one or more input data sources and to determine, based on the one or more sources of input data and on at least one initial set of concepts (e.g., at least one initial ontology), at least one attribute representative of a type of information detail to be included in the new set of concepts.

The system may include a Natural Language Processing Engine such as the one disclosed, for example, in co-owned pending patent application Ser. No. 12/205,614, entitled “MANAGEMENT AND PROCESSING OF INFORMATION,” which claims priority from Provisional application Ser. No. 60/970,635, entitled “Management of Health Care Information” and filed Sep. 7, 2007, the contents of all which are hereby incorporated by reference in their entireties.

In one aspect, a method to generate at least one new set of concepts to be used to perform natural language processing (NLP) on data is disclosed. The method includes receiving one or more sources of input data, and determining, based on the one or more sources of input data and on at least one initial set of concepts, at least one attribute representative of a type of information detail to be included in the at least one new set of concepts.

Embodiments of the method may include one or more of the following features.

Determining, based on the one or more sources of input data and on at least one initial set of concepts, at least one attribute representative of a type of information detail to be included in the new set of concepts may include comparing attributes of the at least one initial set of concepts to the one or more sources of input data to identify non-matching attributes of the at least one initial set of concepts that do not match any portion of the one or more sources of input data.

The non-matching attributes of the at least one initial set of concepts may include attributes that do not semantically or syntactically match any portion of the one or more sources of input data.

The method may further include identifying non-matching portions of the one or more sources of data that do not match any of the attributes of the at least one initial set of concepts, and replacing the identified non-matching attributes of the at least one initial set of concepts with the identified non-matching portions of the one or more sources of data to generate the at least one new set of concepts.

Identifying non-matching portions of the one or more sources of data may include removing from the one or more sources of data one or more of, for example, matching portions that match at least one attribute of the at least one initial set of concepts and/or semantically neutral portions of the one or more sources of data.

The method may further include generating one or more processing rules having one or more search constraints, the one or more processing rules adapted to be applied to input data, the one or more processing rules being associated with the determined at least one attribute representative of the type of information detail to be included in the new set of concepts.

The one or more processing rules may each be associated with one or more groups corresponding to respective levels of rule complexity, wherein at least one group of rules associated with a first level of complexity may be a subset of another group of rules associated with another, higher, level of rule complexity.

The method may further include identifying from an initial set of processing rules one or more processing rules that produce close matches with the one or more sources of data, each of the processing rules of the initial set including one or more searching constraints, and modifying at least one of the one or more searching constraints of the identified processing rules.

Determining the at least one attribute representative of the type of information detail to be included in the new set of concepts may include determining the at least one attribute representative of the type of information detail based on one or more inductive bias assumptions.

The one or more inductive bias assumptions include one or more of, for example, an assumption that consistency and accuracy of a classification operations applied to the one or more sources of input data increases with increased complexity of processing rules applied to the one or more sources of input data, an assumption of maintaining complexity neutrality, an assumption that semantically related terms are interchangeable, an assumption that concept modifiers do not alter the semantic content of a concept, an assumption that a portion within the one or more sources of data input assigned to a function is not available to be assigned to another function and/or an assumption that syntax and the choice of semantic expression used in the at least one set of concepts are dependent.

The one or more inductive bias assumptions may include forward-chaining rules that specify allowable combinations of data portions within the received one or more sources of input data.

Determining the at least one attribute representative of the type of information detail based on one or more inductive bias assumptions may include determining the at least one attribute representative of the type of information detail based on one or more inductive bias assumptions that process the one or more source of input data in a manner that simulates an operation of human knowledge acquisition and storage.

The at least one initial set of concepts may include a continuously updated set of skeleton classifiers. The skeleton classifiers may include skeleton ontologies.

The method may further include determining from the at least one initial set of concepts an optimal set of concepts to apply to the one or more sources of data input to generate the new set of concepts.

The method may further include importing simple concept terms and synonyms from a remote source maintaining lists of simple concept terms, constructing an exact term list from the imported concept terms and synonyms, and generating for the at least one new set of concepts processing rules having search constraints by removing semantically neutral terms in the exact terms list and converting terms remaining in the exact term list to a normalized format. The method may further include augmenting a simple concept lexicon. Generating processing rules may include applying preposition and verb inflection rules and Placement Rules.

The method may further include constructing a database for the at least one initial set of concepts. Constructing the database for the at least one initial set of concepts may include forming complex concept terms from an identified remote source of input data.

In another aspect, an apparatus is disclosed. The apparatus includes a computer system including a processor and memory, and a computer readable medium storing instructions for natural machine learning (ML) processing including instructions to cause the computer system to receive one or more sources of input data, and determine, based on the one or more sources of input data and on at least one initial set of concepts, at least one attribute representative of a type of information detail to be included in the at least one new set of concepts.

Embodiments of the apparatus may include any of the one or more features described herein in relation to the method.

In a further aspect, a computer program product residing on a computer readable medium for machine learning (ML) processing is disclosed. The computer program product includes instructions to cause a computer to receive one or more sources of input data, and determine, based on the one or more sources of input data and on at least one initial set of concepts, at least one attribute representative of a type of information detail to be included in the at least one new set of concepts.

Embodiments of the computer program product may include any of the one or more features described herein in relation to the method and the apparatus.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of an exemplary multi-stage (multi-layer) NLP engine that includes a Machine Learning engine.

FIG. 2 is a schematic diagram an exemplary generic computing system to implement the KEEP system.

FIG. 3 is a flowchart of an exemplary procedure to generate new concept sets (ontologies).

FIG. 4 is a flowchart of an exemplary procedure to complete attribute partial matches and mismatches.

FIG. 5 is a flowchart of an exemplary procedure to generate hypotheses sets (simple concepts sets).

FIG. 6 is a flowchart of an exemplary procedure to generate a complex concept set.

### DETAILED DESCRIPTION

Disclosed herein are methods, apparatus and products (e.g., computer program products) to perform natural language processing, including processing to generate at least one new set of concepts to be used to perform natural language processing (NLP) on data. Performing the natural language processing includes receiving one or more sources of input data, and determining, based on the one or more sources of input data and on at least one initial set of concepts (e.g., a skeleton ontology), at least one attribute representative of a type of information detail to be included in the at least one new set of concepts. In some embodiments, determining, based on the one or more sources of input data and on at least one initial set of concepts, at least one attribute representative of a type of information detail to be included in the new set of concepts may include comparing attributes of the at least one initial set of concepts to the one or more sources of input data to identify non-matching attributes of the at least one initial set of concepts that do not match any portion of the one or more sources of input data.

In some embodiments, the method may further include identifying non-matching portions of the one or more sources of data that do not match any of the attributes of the at least one initial set of concepts, and replacing (“pruning”) the identified non-matching attributes of the at least one initial set of concepts with the identified non-matching portions of the one or more sources of data to generate the at least one new set of concepts. In some embodiments, the method may further include generating one or more processing rules having one or more search constraints, the one or more processing rules adapted to be applied to input data, the one or more processing rules being associated with the determined at least one attribute representative of the type of information detail to be included in the new set of concepts.

The NLP and KR processing engines, referred to as Knowledge Extraction and Encoding Processor (KEEP), is a knowledge-based system that automatically detects and translates predefined knowledge/information in the corpus of both free-text and coded data in the various knowledge domains, for example, the medical domain, industrial domain, business domain, etc. The encoded, translated information is used to auto-populate knowledge bases in decision-support tools. For example, in some embodiments, such knowledge bases may be used to identify clinical events of interest in electronic medical records, to improve search results for medical concepts of interest, and to translate complex medical concepts into consumer-friendly language.

In order to extend the NLP engine capabilities to broader medical, as well as non-medical domains, a machine learning (ML) methodology is implemented that accounts for the underlying structure of the EMD advanced NLP KEEP technology. Such system is configured to classify new, previously unrecognized, language and to automatically construct new classifiers by using previously established functions (“training examples”). In effect, the systems described herein are configured to “teach” themselves to classify new knowledge. In generating new classifiers (i.e., new ontologies), the systems and methods described herein receive one or more sources of input data (e.g., excerpts of publications from one or more subject matter domains), and based on the received sources of data and at least one initial set of concepts (e.g., an existing ontology) generate the new set of concept (e.g., a new ontology). Provided herein is a description of the NLP architecture and details the method used to automatically build new concepts and extend NLP capabilities to previously unrecognized regular expressions.

With the ever-expanding body of medical information available in both professional literature and in electronically maintained medical records (EMRs), there is a need for more accurate and efficient ways to find, codify and manage medical information to optimize the information exchange and the quality of clinical performance. KEEP and NLP technologies, disclosed in the application “Management and Processing of Information”, accomplish this by applying a set of application-specific logical rules to virtually any text within the corpus of medical literature (free-text, structured data elements, EMR content and coded data). The KEEP technology uses forward-chaining logic rules to map regular expression inputs to target concepts (target functions) within a domain-specific ontology. This system has applications in addressing a wide variety of concerns in the areas of health service and research as well as in clinical operations including care quality, disease detection and surveillance, production and maintenance of decision-support tools, and enhanced medical search engine capabilities.

Efficiently extending the NLP capabilities to an ever-growing number of sub-domains within health care, as well as beyond health care, requires automating the process that is used to generate new domain-specific ontology and their related classifiers. The EMD ML structure described herein is based on the KEEP architecture but may be generalizable for use with other systems.

Conventional ML technologies rely, at least in part, on computational models to approximate the human learning process. In contrast, in some embodiments, the EMD techniques described herein have adopted a model that seeks to more accurately simulate the way that humans store language and compile new language understanding based on previously learned language patterns.

In conventional NLP and ML models, knowledge tends to be stored, for the most part, as small discrete units that are members of categories. These categories are linked to each other according to specified types of relationships. It is assumed that humans, on the other hand, store knowledge not as small discrete units, but rather as complex or compounded combinations of main and subsidiary ideas (subject clauses and modifier clauses) which are referred to as “compounded or complex concepts”. Underlying this principle is the assumption that it is more computationally efficient to store knowledge this way. In addition, it is assumed that the level of complexity of stored information varies based on its importance to a given human individual. Based on this assumption, an ontology structure may be organized into hierarchical parent/child categories with increasing level of detail within sub-classes.

In addition, another assumption regarding the human storage model is that the human mind stores these complex concepts as specific instances of generalizable “skeleton templates”. The skeleton templates contain certain words or abstractions in specific (syntactical) order, and these templates may be reused by substituting new words or abstractions (“simple concepts”) that have different semantic value into the appropriate placeholders. In other words, the model operates on the assumption that human can store knowledge by determining parallels between analogous sets of data (e.g., sets of data that are analogous to each other in one sense or another). These multiple skeleton templates are stored, reused and reapplied to express any number of ideas. The systems described herein reuse these templates to build new complex classifiers (constraint sets) that correspond to new ontology branches. Many classifiers are typically built for each branch and represent different ways to express the same idea.

Another assumption that can be used is that new language acquisition is accomplished, at least partially, through adding new skeleton classifiers with new syntactical/semantic variations, reflecting the fact that there are many and varied ways to say the same thing. The exact forms of the words or abstract categories (e.g., part-of-speech or inflection) that are allowed in the template depend, in part, on the particular syntactical construct chosen for the classifier (additional assumptions that may form the basis for implementing machine-learning based approaches for generating new classifiers may include the assumption that semantics and syntax are dependent, and that allowable semantic choices vary based on syntax).

The ML methodology described herein stores skeleton representations of complex patterns that it effectively “learns” from “teaching examples” in the form of forward-chaining techniques. These classifiers organize specific words (and their synonyms), groups of semantically equivalent and interchangeable expressions, and abstract concept placeholders. In some embodiments, the attributes within these classifiers are organized in relation to each other by syntactical constraints. When new, unclassified knowledge is presented to the ML engine, the system determines which skeleton classifiers best matches the new data, and which tokens from the data should be substituted into the template to complete the match, for data which contains a new knowledge category that has not previously been covered. Input data is said to match a classifier when all constraints are met.

Generally, when previously unclassified information is present in a particular input example, the system analyzes which classifier (e.g., concept set or ontology) is the best fit and “completes” the match by identifying the specific terms or abstract category that needs to be substituted into the template to accurately represent the new knowledge. Once the right “fit” is established, the system incorporates similarly edited “sister” classifiers into the hypothesis set for this particular knowledge category. In effect, the classifiers within a target function are complex synonyms.

In some embodiments, the ML approach described herein includes options for supervised, unsupervised, and semi-supervised learning, as well as for transduction. To facilitate ease of development in the supervised model, the technology has been developed with a user interface that accepts natural language so that it is readily accessible to the untrained end-user. Specifically, new classifiers can be written in natural language words/phrases. Under those circumstances, the system automatically assigns synonyms and “semantic equivalents” and automatically causes the corresponding classifier changes.

Systems (and methods) implementing machine-learning approaches based on the assumptions described herein present several advantages:
1. Such systems enhance the consistency and accuracy of existing classifiers. A goal of the ML engine, and, more generally, the systems described herein, is to augment existing NLP-based systems by operating (e.g., editing/modifying) existing teaching examples for improved consistency. Thus, an ML engine should be able to pinpoint the reason that an erroneous input/output non-match occurs and offer a hypothesis (of attributes or syntax changes) to correct the error.
2. The systems described herein provide new target functions within an existing ontology that represent a subset of an existing knowledge category. Ontology structure is organized so that sub-set (child) nodes reflect an increasing level of knowledge specificity/detail. The ML engine should recognize when an input data source (e.g., input text) is a more specific subset of an existing ontology node.
3. The systems described herein automate the production of new classifiers for new domains. The ML engine of such system are thus capable of using previously generated hypothesis sets to build new hypothesis sets for different domains, without the need for domain-specific teaching examples. In addition, the ML technology should be transportable such that it automates the production of new hypothesis sets for diverse subject matter domains (e.g., domains that include healthcare applications, industrial application domain, business application domains, etc.)
4. Such systems are configured to function in either a supervised or unsupervised environment. A supervised environment generally has the advantage of improved consistency. An unsupervised environment, on the other hand, offers rapid development timeframes which would be particularly advantageous when applied to domains outside of healthcare.
5. Such systems automate consistency improvements for high-level rules (such as placement rules, which define rules specifying which tokens within a source data may be linked together and therefore may be analyzed as a unit for a given attribute. etc). The ML engine of such systems should be configured to recognize erroneous non-matching high-level rules/constraints, identify the reasons for such inaccuracy, and suggest corrective rule edits.
6. As will be described below in greater detail, the systems disclosed herein maintain complexity neutrality. Particularly, in some embodiments, when one classifier attribute constraint is disabled, the ML engine automatically adjusts (e.g., increases) the complexity of the system by adding a different constraint or parameter (also referred to as feature variable, or FV). Such automated functionality enables the ML engine to simulate a process used by human system developers to maintain system accuracy.
7. Such systems achieve computational efficiency by condensing and streamlining classifier functions. In some embodiments, the ML engine recognizes redundant classifiers and/or redundant variables within classifiers. Such the redundancies should be reduced to thus maximize the computational efficiency.

The KEEP NLP engine architecture includes modules to implement the above-described ML functionality. These modules implement ML processes that, for example, automatically edit existing classifiers, build new classifiers and target functions, and reconfigure high-level system rules (e.g., processing rules, also referred to as SmartSearch rules), that are associated with the attributes of a classifier and are used to perform, for example, natural language processing on input data). A description of the KEEP NLP system is provided, for example, in co-pending application Ser. No. 12/205,614, entitled “Management and Processing of Information”, the content of which is hereby incorporated by reference in its entirety.

Particularly, and as described in the “Management and Processing of Information” application, the Knowledge Extraction and Encoding Processors (KEEP) system uses four distinct informatics technologies: (1) at least one ontology (i.e., a set of concepts relating to one or more subject matters and the relationships between at least some of the concepts) of contextualized concepts in which the ontology represents concepts as existing in context (as knowledge) in addition to representing them as basic/atomic units that can be further contextualized to fine-tune categorization or the assignment of meaning; (2) a hybridized semantic/syntactic rules-based processor that analyzes the meaning and structural properties of sentences/phrases as dependant rather than independent variables, thus resulting in an implementation that more precisely simulates human language processing which has been developed as a customized application program interface (API) for content development without programming experience; (3) a robust domain-specific Knowledge Representation (KR) model linked to translation templates that have placeholders in which specific instances of classes of data can be populated as they are identified within source text; and (4) a system to dynamically customized (or generates) ontology.

The KEEP system provides automated coding and classification of free-text from diverse sources of information, including, but not limited to medical information, as well as from digitized clinical records. The system automatically identifies clinical information of interest to professional and non-professional end-users, generally by auto-populating information into decision-support knowledge bases.

The KEEP system processes large volume of information to auto-populate decision-support knowledge bases of the system at a high accuracy rates, scalability and efficiency. For example, in some embodiments, the KEEP system may be required to process millions of records (for example, to auto-populate a knowledge base pertaining to a drug-related decision-support product, as described in the “Management and Processing of Information” application).

The KEEP system's high-level architecture includes several modules. Particularly, the KEEP system includes a Natural Language Processing (NLP) engine implemented, in some embodiments, with four separate layers, and a machine learning (ML) engine to develop/generate new ontologies based, at least in part, on existing ontologies developed, stored and/or maintained on the KEEP system.

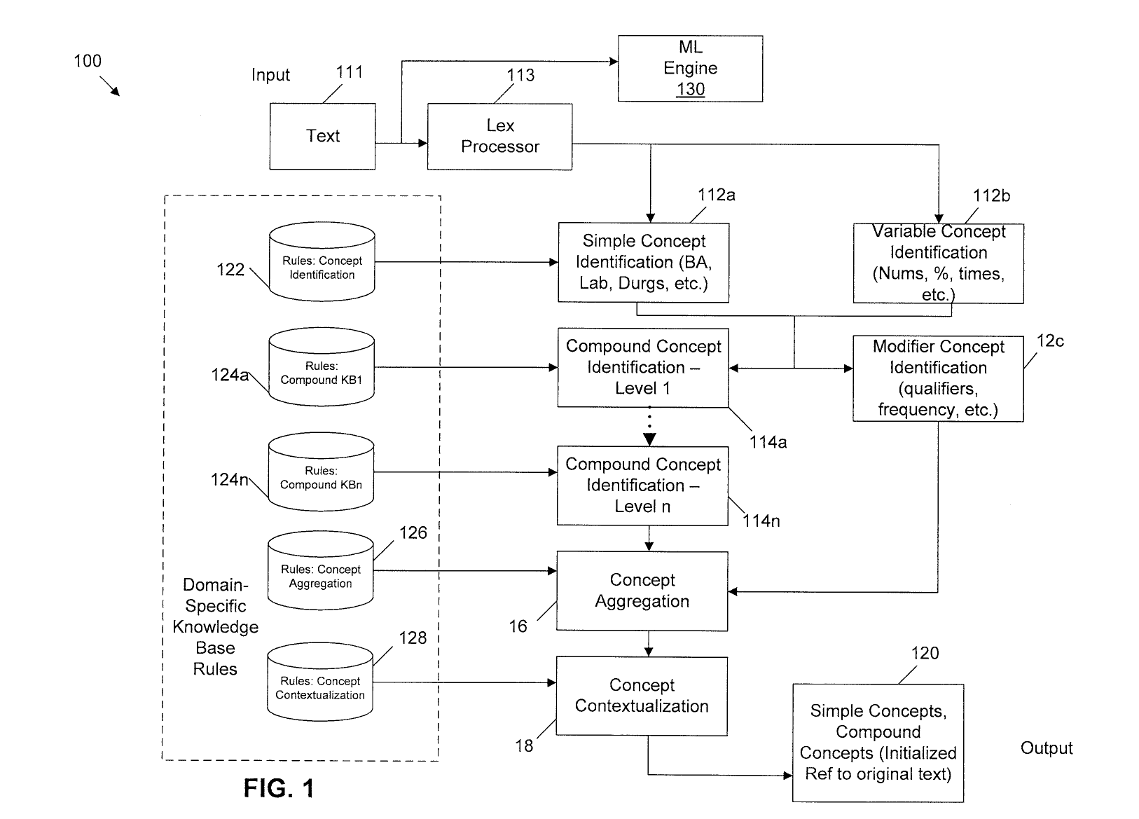

Referring to FIG. 1, a block diagram of an exemplary multi-stage (multi-layer) NLP engine 100 is shown. The engine 100 includes, in some embodiments, a simple concept identification layer 112. This layer identifies the abstract concepts (e.g., medical concepts), represented in the concept ontology, that are contained in free-text portions of the input data. The abstract concepts are drawn from the concept ontology in which concepts are classified to specific classes of interest. Concept identification is performed using a series of NLP procedures. Concepts are said to be fully “instantiated” when additional context captured by concept modifier logic is attached to the concept.

Another layer of the NLP engine is the Compound Concepts/Knowledge Classification layer (also referred to as the Complex Concept layer) 114. This layer implements classification of source text against Knowledge Representation categories using a rules-based classification engine. Instantiated concepts produced during the first stage of analysis, along with other tokens within the sentence(s), are run against the rules to determine for which rules constraints (e.g., defined in SmartSearch rules) are met. For each domain of interest, a comprehensive set of knowledge classes is defined that would be of interest to the target end-user(s). As further shown in FIG. 1, the Compound Concepts/Knowledge Classification layer comprises several sub-layers 114ₐ-114ₙ, each of which corresponding to a higher level of complexity in that higher levels incorporate increasingly more contextual information from the input data source, a larger number of concepts and, typically, more constraints within its associated rules. Lower level rules are often a subset of higher level rules. In some embodiments, another level of “clustering” in which secondary relationships are maintained may be performed. For example, with respect to the input free-text excerpt “Sjogren's syndrome can occur as an adverse reaction to a particular drug and the manifestations of the syndrome include dry eyes, rash . . . ”, the system can recognize both the syndrome and each element of its manifestations as an adverse drug reaction to the specific drug and can also recognize the cluster of symptoms that are secondary to the syndrome.

A further layer of the NLP engine is the Concept Aggregation layer 116. Concept modifiers are evaluated by domain-specific sets of forward-chaining logical rules for each concept identified within the data source segment. Modifiers include severity, frequency, quantity, timing, quality, etc. Modifiers are “attached” or linked to corresponding concepts.

Yet another layer of the NLP engine is the Concept Contextualization layer 118. This layer evaluates the context within which each concept exists and applies a set of hierarchical rules to reconcile overlapping, redundant, or contradictory rules.

The NLP engine also includes the functionality for translating the semantic contents represented by each node on the Knowledge Representation tree. This layer translates abstract classes of knowledge (e.g., medical knowledge, or knowledge from any other subject matter domain) identified within source data from formal professional language into common language. Each rule linked to a Knowledge Class within the Knowledge Representation tree maps to a standardized template with placeholders into which specific instantiated concepts can be populated. Knowledge can be translated into common English or into other languages.

With more particularity regarding the operations performed by the engine (or apparatus) 100, the functions performed by the various layers are based, in some embodiments, on rules defined in associated rule sets (stored, for example, in one or more storage devices coupled to the engine 100). Thus, for example, at least some of the operations performed by the Simple Concept Identification are based, at least in part, on rules defined in the rule set 122.

The NLP engine 100 receives source data 111 from, for example, on-line sources available on private or public computer networks. The data 111 thus received is initially processed by a lexicon processor 113 that performs language normalization on the received data. Such language normalization processing may include tagging recognizable words in the received data source that may pertain to the general subject matter with respect to which the knowledge-based system is being implemented.

The source data, which may have been intermediary processed by the Lex processor 113, is then processed by the concept identification stages of the engine 100, which include simple and complex concept identification stages.

The Simple Concept Identification layer 112 of the NLP engine 100 is configured to identify basic units of semantic content within source text. This layer's primary function is to transform free-text into structured, abstract concepts within the concept ontology. The general form of this knowledge representation is a collection of many different instantiated concepts (e.g., medical concepts) drawn from a common language, as well as medical language ontology. The ontology is a set of possible abstract concepts and relationships among those concepts. Each abstract concept in the ontology may be associated with a unique concept identifier which links together synonymous terms/phrases, including formal and common language terms. In some embodiments, for applications to process medical records, a typical repository of synonyms may include in excess of 100,000 discrete terms of synonyms.

The transformation of raw data into knowledge representation in this layer of the architecture entails identification of the ontology concepts represented by the terms contained in segments of input data portions containing natural language text. Thus, the system (shown in FIG. 1) performs free-text processing on all segments of data contained within the data source in, for example, a four-stage process. First, the entire text is parsed by the lexical processor 113 for sentence boundaries and other patterns of interest (word segmentation, lemmatization, stemming, delimiter identification). In the next series of processes, separate stacks of increasingly complex rule knowledge bases sequentially process bounded data. In the second step, which follows the establishment of boundaries and semantically related tokens, each token identified in the data is subjected to processing involving tokenization and word variant generation (including synonyms, acronyms, abbreviations, inflectional variations, and spelling variations).

Third, each set of tokens within a sentence (or under certain circumstances, sentences) is subjected to a high-level syntactical processor (HSP) that uses a set of domain-specific procedures that specify the tokens within a segment that are semantically linked and, therefore, can be processed as a group by the set of rules (e.g., placement rules). This stage also addresses word segmentation ambiguity issues. Fourth, candidate token groups are evaluated against forward-chaining logical rule-sets that are linked to ontology classes to determine the classes which are invoked in the text. Rule-level constraints determine which individual concepts/tokens apply to the rule. Abstract concepts or word forms may be optional, required, excluded, or have a required order. One or more word forms from within a group of lexical items may be required. Exclusions may be specified at a global, rule-specific level, and they may also include negations, idioms, etc. Delimiter identification is specified at the rule-level as well. Fifth, fixed expressions/multi-word expressions are identified by string matching. These “Exact Term” matches are linked to ontology classes. Concepts are “triggered” or “fire” when the constraints of one or more of the rules that define that concept are met. More specifically, if the constraints of one or more of the forward-chaining logical rule (e.g., SmartSearch rules) associated with a concept are met, or one or more exact terms “fire”, then the concept is said to be “classified”. Generally, the data segments are tested against alternative rules-sets from closely related knowledge representation constructs that are easy to confuse with the concept of interest (because of over-lapping rules constraints or matches). If one or more of the rules associated with associated knowledge representation constructs from a higher level, then the more highly detailed, or “child” level concept, rather than the original concept of interest, “fires”. Additionally, text segments that contain classified concepts are tested against forward-chaining logical rules for associated modifiers. These may include additional information that describe or add semantic content to the concept, including frequency, severity, duration, course over time, response to exacerbating/alleviating factors, strength of evidence, etc.

To achieve a higher level of accuracy (specificity and sensitivity) in identifying and codifying semantic content within data (e.g., free-text data), an innovative approach to rule construction and processing strategy is used. The approach used to perform the forward-chaining logic rules is predicated on the underlying assumption that allowable semantic forms/expressions are dependant on more finely specified subcategories of semantic forms that are typically used with other NLP engines, and the choice of which is determined by the specific syntactical and semantic construct that is used within a rule. The implemented approach enables customization of semantic content for each rule that is based on a combination of the specific type of knowledge being represented and on the syntactical construct represented within that particular rule, subcategories of parts of speech, inflections, etc.

To implement the forward-chaining logic rules procedure, generalizable syntactical constructs, referred to as “Syntactical Rule Model set” (SRM), can be used as the initial structural basis for rule development. SRMs are abstract frameworks that specify possible POS/CONCEPT order combinations. For each concept, a subset of appropriate SRMs is selected. These abstract frameworks are then populated with specific words/word forms appropriate to the semantic content of the concept and to the SRM structure. It is to be noted that in some embodiments, an SRM may be implemented that provides an application-program-interface (API) that is content-developer-friendly.

Each concept is typically defined by several to many rules. Each rule is an instance based on Syntactical Rule Model (SRM) set. Each rule incorporates a pre-defined, structured, specific POS/concept configuration. Based on the SRM configuration and the semantic representation reflected by the concept, a subset or allowable semantic expressions are customized for each constraint within the rule.

As further shown in FIG. 1, the engine 100 includes an ML engine 130 that receives input data source(s) pertaining to a particular subject matter domain and based on the received data and existing concepts sets (ontologies) it constructs (generates) new ontologies pertaining to the received source data. Further details regarding the ML engine 130 are provided below.

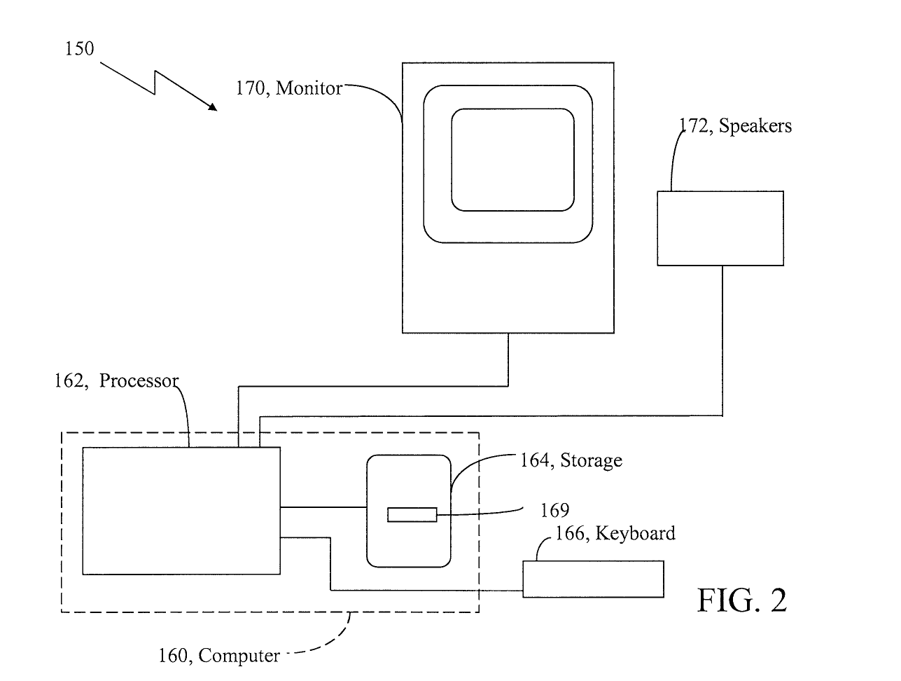

Referring to FIG. 2, an exemplary embodiment of a generic computing system 150 to implement the KEEP system is shown. The computing system 150 is configured to process information accessed on private and public computer network and perform contextual processing, as described herein, to construct knowledge-based system, including generating concept sets based on existing sets and received data. The computing system 150 includes a computer 160 such as a personal computer, a personal digital assistant, a specialized computing device or a reading machine and so forth.

The computer 160 of the computing system 150 is generally a personal computer or can alternatively be another type of computer and typically includes a central processor unit 162. Suitable processors include, by way of example, both general and special purpose microprocessors. The computer 160 may include a computer and/or other types of processor-based devices suitable for multiple applications. In addition to the CPU 162, the system includes main memory, cache memory and bus interface circuits (not shown). The computer 160 includes a mass storage element 164, here typically a hard drive. The computer 160 may further include a keyboard 166, a monitor 170 or another type of a display device.

The storage device 164 may include a computer program product that when executed on the computer 160 enables the general operation of the computer 160 and/or performing procedures pertaining, for example, to the construction of knowledge-based databases and/or the generation of ontologies. Each computer program can be implemented in a high-level procedural or object oriented programming language, or in assembly or machine language if desired. The programming language can be a compiled or interpreted language.

In some implementations the computer 160 can include speakers 172, a sound card (not shown), and a pointing device such as a mouse 169, all coupled to various ports of the computing system 160, via appropriate interfaces and software drivers (not shown). The computer 160 includes an operating system, e.g., Unix, Windows XP® Microsoft Corporation operating system. Alternatively, other operating systems could be used.

Although FIG. 2 shows a single computer that is adapted to perform the various procedures and operations described herein, additional processor-based computing devices (e.g., additional servers) may be coupled to computing system 150 to perform at least some of the various functions that computing system 150 is configured to perform. Such additional computing devices may be connected using conventional network arrangements. For example, such additional computing devices may constitute part of a private packet-based network. Other types of network communication protocols may also be used to communicate between such additional devices.

Alternatively, the additional computing devices may be connected to network gateways that enable communication via a public network such as the Internet. Each of such additionally connected devices may, under those circumstances, include security features, such as a firewall, VPN and/or authentication applications, to ensure secured communication. Network communication links may be implemented using wireless or wire-based links. Further, dedicated physical communication links, such as communication trunks may be used.

The ML Engine

As noted, the KEEP system further includes an ML engine 130 configured to, among other things, generate, store and maintain at least one ontology. Each of the ontologies maintained by the ML engine 130 may pertain to one or more subject matter domains (e.g., health science domains, industrial applications domains, etc). A domain-specific ontology may thus be generated (or constructed) for each domain served by the system. The ontology branches in KEEP are made up of compounded concepts which are conceptualizations that incorporate one or more main idea or subject (“simple concept”) with one or more secondary concept (modifying clause), which further describe or modify the main idea. The rationale for storing knowledge in a compounded or complex form is based on the idea that more complex knowledge configurations represent a more economical way to store, maintain, and manipulate knowledge, and provide a more consistent, less error-prone basis for machine learning functions.

As noted above, the underlying assumptions regarding storage of data in accordance with an ontology branch configuration is based on EMD's theoretical model related to human knowledge storage, namely, that humans store knowledge most efficiently in complex configurations. For example, an infrequent traveler stores “hotels brands in which I like to stay” whereas a frequent traveler has a category for “specific hotels (that differ by city/location) that have exercise facilities in which the frequent traveler likes to stay when he/she travels for business”. Storing knowledge in bundled units may result in an increased level of computational efficiency since a large number of relationship/associations do not have to be recalculated, reprocessed and/or re-established each time a particular type of knowledge is called-up to memory. The idea that machine learning applied to compounded concept is less error-prone is based on the observation that the larger the number of variables (attributes) included in a function (such as a classifier function), the more consistent the function would generally perform to correctly identify input-output matches.

Ontology branches are organized so that “child” branches represent an increasing level of detail related to the main idea (e.g., in relation to the pharmaceutical drug domain, a detailed child branch may correspond to specific drug rather than to a more general class of drug; in relation to a business or industrial application domain, a detailed child branch may be a range of frequencies branching from a parent node corresponding to, for example, an upper limit). As will be described in greater detail below, this highly structured organization methodology enables the addition of new knowledge categories more readily through the machine learning process. Partial matches are categorized as subsets (children of) or parents of existing target functions based on the level of specificity of the information included in the input text.

Each knowledge branch within an ontology may be composed of one or more variables (“attributes”). Attributes may be conceptual (abstract or specific representations), numerical, or of some other type. Conceptual attributes include exact terms for which there may be no substitutions. Such attributes may also include specific terms that also represent synonyms, abstract placeholders for any number of specific terms, or a group of terms from which, to satisfy a constraint, any one may be chosen (“Semantic Group”). In addition, for each conceptual attribute, a particular part-of-speech (POS) may be specified (e.g., verb, noun, etc.)

The attributes of an ontology are each associated with one or more functions, or rules, that are applied to input data to ascertain the meaning of the data using the ontology. For each function, syntactical rules specify the order in which tokens are displayed in the input text in relation to the other tokens. Where the rules include syntactical “punctuations” developed for the KEEP system, the use of such punctuations indicates that a specific order is not required, or that one token is positioned before or after another specified tokens. For example, the syntax “dot dot dot” (i.e., “ . . . ”) means a specified order for particular attributes with respect to which other text may appear between those specified attributes. A space (i.e., the syntax “ ”) means a specified order with respect to which other strings may not appear between the attributes in question. A comma (“,”) means that order is not specified and that other text may or may not appear between. Such punctuations can thus specify which tokens within a data source have to be contiguous for a rule to be satisfied, and which token may be separated by other words. Syntactical rules are applied to attributes to specify their spatial relationship in the source text to one another. In addition, because attributes themselves specify more than one token within input text, the same syntactical rules are applied within attributes as well as between them.

The high degree of flexibility in the ability to specify which particular words, synonyms, parts-of-speech, etc., are allowed, based on a given syntax, enables the KEEP system to perform NLP with a relatively high level of accuracy. Such accuracy is achieved by treating semantics and syntax of a source data as including dependent rather than independent variables. It also establishes a basis for an approach to machine learning in which the system keeps track of, and provides constraints regarding which word forms are allowable, based on the syntax of the input data. In this case, the ML engine may learn which forms are allowable by using information present in teaching examples, using high level techniques that specify allowable syntax/part-of-speech/inflectional combinations, and using cues in the input data (e.g., input text) itself including specific word(s) and word orders within the data.

The KEEP system organizes knowledge by drawing a distinction between simple and compounded (or complex) concepts. In part, the reason for this distinction is that simple concepts typically incorporate fewer attributes in their associated functions and therefore, according to the Complexity/Consistency assumption (as described herein), are less consistently correct in their input/output categorizations. To improve consistency for this group, a higher-level rule set, called “Placement Rules” is applied to input data to recognize associations among the individual tokens. In other words, Placement Rules are used to determine which tokens within a source data may be linked together and therefore may be analyzed as a unit for a given attribute. For example, consider the input data “increased dose causes blood sugar readings to sometimes decrease”. Conventional NLP systems that rely on proximity-based rules may incorrectly assign the term “increase” to “blood sugar”. In contrast, a multi-stage NLP processing performed using the EMD Placement Rules described herein analyzes the context within which the increase/decrease terms are used to enable the correct assignment/linking of tokens (in this case, to determine that the word “increased” is in fact associated with “dose”). Placement Rules also use a forward-chaining implementation to disambiguate relationships among multiple tokens.

Most concepts are governed by a basic set of general Placement Rules. Customized Placement Rules may be developed, however, for token combinations that are more commonly used within a particular domain (for example, rules that govern the terms “increase/decrease”, or terms that describe “location” may be more particularly fleshed out in medical application domains). One implication of having Placement Rules as a part of the system is that the ML engine, among some of its operations, is configured to modify existing Placement Rules and provide new ones as part of the learning or adaptation process(es).

The ML engine 130 described herein refines the natural language processing capabilities of the KEEP system within the domains (e.g., the medical domains) for which it has already been developed, and to extend NLP capabilities to other domains, as well as to those outside of healthcare, by automatically customizing existing functionality to different types of knowledge/input.

The EMD ML engine 130 is implemented based on a conceptual modeling that enables expedient and efficient development of ontologies (for diverse subject matter domains) to facilitate NLP processing. The implemented modeling is predicated on a number of inductive bias assumptions.

A set of inductive bias rules and other assumptions form the basic underlying hypotheses around which the ML engine and is implemented methodology to generate new ontologies. Inductive bias assumptions are assumptions that a learner (e.g., a learning machine) may use to predict outputs given inputs that it has not encountered. To process new input data, a learning machine applies a learning process to training examples to establish the intended relationship between input and output values. The established learning process can then be applied to input data that it previously did not encounter to generate resultant output that is reflective of the response of the learning process to the new input data. The learning process, implemented on the learning machine thus approximates an output based on the training input data used to establish the learning process. The assumptions relied upon by the learning process (also referred to as a target function) are referred to as inductive bias assumption. Inductive bias assumption can be defined using, for example, mathematical logic. In some embodiments, the inductive bias assumption can be represented as guidelines that guide the learner to determine the output responsive to the input presented.

Some of the different types of inductive bias assumptions (or rules) that may be relied upon to define or represent the learning process that is to be implemented by the ML engine 130 include the following inductive bias assumptions.
1) Complexity/Consistency Relationship—This inductive bias rule assumes a direct relationship between complexity and consistency, and assumes that consistency/accuracy increases with increased rule complexity (increased complexity may refer, in some embodiments, to increase in the number of parameters, variables and/or syntactic constraints specified within a function). Based on this assumption, simple concepts, for which there are typically few parameters (or constraints) are less consistent in defining input/output relationships accurately compared to compound concepts that incorporate more parameters/variables/constraints. Put another way, as a relatively larger number of terms are available within an input data source (e.g., a text string), the incorrect pairing of unrelated token becomes more likely. When constraints cover a high percentage of potential tokens within a text string, relatively fewer terms are available with which to construct incorrect token pairing.
Recognizing the tendency for inconsistency when identifying simple concepts, the NLP system uses a second order of rules, namely, “Placement Rules”, which apply an additional level of constraints to simple concepts. As described herein, these rules are forward-chaining techniques that specify allowable token combinations for the tokens that appear within an input data source. These rules analyze the context within which potentially related tokens reside within the source and determine, based on the context, whether this combination is allowable.
Input/output matches can erroneously fail based of flaws within Placement Rules that become apparent when applied to new data sources. The ML engine is configured, in some embodiments, to identify the reason for rule failure and to suggest corrective changes to the Placement Rule automatically. The ML engine 130 also automatically applies existing Placement Rules to newly built simple concepts. Thus, placement rules may be applied to a string to determine which terms within the string are allowable for pairing.
2) Maintaining Complexity Neutrality—When input/output erroneously fail to match, one available option of the ML engine to correct the problem is, under certain circumstances, to decrease/relax the number of constraints that are applied by the invoked classifier. To maintain consistency, according to the Complexity Neutrality inductive bias rule, the system adds a variable or constraint to the classifier (e.g., to a processing rule, such as a SmartSearch rule) for every constraint removed, to maintain the level of complexity and, therefore, consistency. The approaches that are used to add variables are described in greater detail below.
3) Semantic Group Interchangeability—The assumption of interchangeability refers to circumstances in which within a given context, terms/clauses that are not actually synonymous are nevertheless sufficiently close in meaning that they are essentially interchangeable (Semantic Equivalents). This assumption holds true even for classifiers that combine different parts-of-speech (e.g., nouns, verbs, adjectives, adverbs, prepositions, conjunctions, etc). Based on this premise, the system maintains in its database lists of semantic equivalents that are organized into “Semantic Groups” for interchangeable use for a classifier constraint or parameter. Thus, when determining, in the course of ML processing, whether portions of an input source match attributes of a classifier, a match may be deemed to have been established even in situations in which an particular portion (e.g., a word) does not form an exact match with the attributes/constraints of an initial skeleton classifier, but nevertheless corresponds to another interchangeable attribute. Put another way, the added constraint/attribute is substituted in the place of the unmatched constraint.
Additionally, a secondary relationship between Semantic Group members is also maintained in the database. For example, two variables in two different Semantic Groups are said to have a secondary relationship if they share a third variable that appears in each of their respective Semantic Groups.
Semantic equivalents are used by the ML engine during the process of identifying tokens within input data sources to “complete” partial matches. In other words, the system searches within the input data for semantic equivalents that may be inserted into classifier templates to correct inaccurate input/output non-matches. The system edits the non-matching constraints to incorporate the semantically equivalent variable(s) that is identified within the input data source. In some cases, a new semantic group is built as a new constraint as the new token is added to a stand-alone semantic equivalent. In some cases, the new token is simply added to a semantic group when one already exists.
4) Modifiers, Repeating Abstract Concepts and Semantic Neutrality—This assumption provides that modifiers/qualifiers (including adjective, measures, units, location, ranges, statements of extent/severity, etc.) do not alter the basic semantic content of a knowledge unit, but add qualifying information to this unit. Based on this assumption, when qualifying information is identified within input data, and the knowledge category to which this input data should be mapped has not yet been built, the ML engine will automatically add a new knowledge category to the ontology as a subset of the more general corresponding knowledge branch.
This assumption also holds for repeating abstract concepts (e.g., “DRUG1 and DRUG2 in combination . . . may cause SIDE EFFECT 1, SIDE EFFECT 2, SIDE EFFECT 3 . . . ”). In other words the appearance of multiple, rather than single instances, of an abstract concept within input data is generally considered a subset of a knowledge node that contains fewer (or none) repeating abstract concepts. Forward-chaining induction rules are used to determine, based on context within the input data, which syntactic/semantic patterns represent repeating abstract concepts.
The implications of this assumption extend further than the production of new ontology branches. Modifiers and repeating abstract concepts are considered as “filler” or “semantically neutral” portions when identifying tokens within an input data that are eligible for submission into a skeleton classifier to build a new rule.
5) Exclusivity in Token Assignment—The ML engine assumes that, unless otherwise specified, tokens tend to be available for use exclusively by one function/classifier. In other words, once a token is assigned to a classifier, it is generally not available for assignment to other functions. Exceptions include key abstract concepts to which multiple clauses within a sentence/string might refer (e.g., side effects, medical conditions, treatments, etc.) and modifiers which apply to a list of terms (e.g. location, increase/decrease, etc). (Note that Placement Rules establish when a modifier semantically applies to multiple tokens within an input string).
An important implication of the exclusivity assumption is that when producing a new function, the ML engine removes from consideration any tokens that are already used or engaged (the so-called “Engaged Tokens”). If the ML engine cannot complete a partial match using Semantic Equivalents, the engine narrows the possibilities of tokens within the input data to identify the tokens that are eligible for population into the skeleton classifier to complete the match. This narrowing is accomplished by removing engaged tokens and/or repeating abstract concepts and modifiers from the pool of potentially matching tokens.
6) Syntax/Semantic Dependency—When constructing new rules, the ML engine invokes the Syntax/Semantic Dependency rule (or assumption) which states that allowable forms of the components specified within a constraint (POS, inflections, etc) differ based on syntactical organization of the classifier. In other words, this assumption states that syntax and the choice of semantic expressions for classifiers are not independent. Thus, allowable parts-of-speech for a particular token within the classifier are dependent on the syntactical arrangement that is selected. Moreover, the dependency relationship cannot be predicted based on part-of-speech (POS) or inflection alone, but is specific to the semantic term. So, for example, NOUN . . . PREP . . . ADJ may be the syntax used for certain regular expressions, while ADJ . . . PREP . . . NOUN is a standard for others.
Standardized syntactical rules that are based not only on POS but also on a combination of POS and exact expressions may be used in some implementations. For example, the systems described herein use over 200 of such developed rules that are used to automatically generate “sister” classifiers to recognize different ways to express the same basic concept (sister classifiers represent iterations of the various possible combinations and order of terms/phrases that can be used to express the same idea).
As an example, consider the complex concept “Demographic—age” of the Risk Factor ontology.
Two SmartSearch rules associated with this complex concept include
“percent . . . [prep23] . . . CONDITION{AGE} . . . [developSG]” and “patient . . . [developSG] . . . are . . . CONDITION{AGE}”
In this example, the use of the exact word “percent” (or its synonym/equivalent), establishes that the age placeholder has to be before the “develop” Semantic Group within the text string. If the exact expression “patient” or its synonym/equivalent is in the string, the age placeholder CONDITION{AGE} (which is a complex expression in itself, defined by another set of SmartSearch rules) has to be located after the age placeholder within the text string.
Note that the word “are” is a placeholder that specifies that substitutions can only include a group of equivalent verbs that apply to pleural nouns. The syntax “[prep23]” represents a specific group of prepositions. In other words, the specific or exact semantic terms that are present within the SmartSearch rules define the syntax requirements of constraints within the rules.

In some embodiments, the ML engine 130 is a machine learning system configured to iteratively analyzes training input data and the input data's corresponding output, and derive functions or models that cause subsequent inputs to produce outputs consistent with the machine's learned behavior. The ML engine 130 is thus configured, for example, to accept as input data sources corresponding to domains it did not previously encounter and to construct from that input new ontologies. Thus, initially a training data set may be used to define the response of the learning machine. The training data set can be as extensive and comprehensive as desired, or as practical. At the end of the learning process, the learning machine is ready to accept input corresponding to one or more subject matter domains so as, in some embodiments, generate new ontologies to facilitate natural language processing. In some embodiments, the ML engine 130 is configured to process input data based on pre-defined procedures (e.g., adaptive processing and/or computations).

In some embodiments, the ML engine 130 may be implemented, at least in part based on, for example, a neural network system, a support vector machine, decision trees techniques, regression techniques, and/or other types of machine learning techniques. Such machine learning techniques and/or implementations may be used, for example, to determine (or to facilitate the determination) of the “closeness” of matches between the input data sources and the ontology attributes (and/or their associated processing rules) against which the input data sources are compared.

As noted, the ML engine 130 of the system 100 may be applied to one or more data sources to determine, based on the one or more sources of input data and on at least one initial set of concepts (e.g., a skeleton ontology corresponding to a particular subject matter domain), at least one attribute representative of a type of information detail to be included in a new set of concepts (a new ontology corresponding, for example, to another subject matter domain). In some embodiments, the ML engine is implemented on the basis of one or more underlying induction bias assumptions (or rules) that guide the processing of input data to generate the new set of concepts.

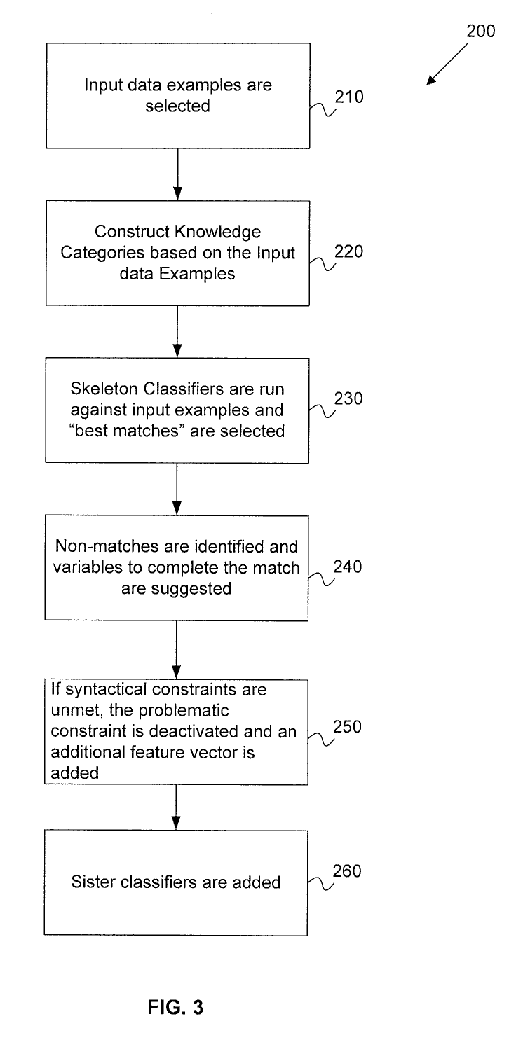

Referring to FIG. 3, a flowchart of an exemplary procedure 200 to generate concept sets (ontologies) is shown. By applying the procedure 200 to input data sources drawn from diverse subject matter domains for which the NLP engine does not have an existing set of concepts (i.e., an ontology), the use of the implemented NLP engine 130 may be extended to new domains. In some embodiments, the generation of new ontologies is performed through the EMD ML system described herein. As shown in FIG. 2, generation of a new set of concepts for a new ontology includes:

1) Selecting 210 input data examples for each branch of the ontology.

2) Constructing 220 knowledge categories labels for each ontology branch either by an end-user (when implementing a supervised model of generating new ontologies) or by pruning of the selected input example (when implementing the non-supervised model of generating new ontologies). As will become apparent below, pruning the selected input examples includes identifying non-matching portions of the one or more sources of data that do not match any of the attributes of the initial set of concepts (i.e., the skeleton ontology), and replacing the identified non-matching attributes of the at least one initial set of concepts with the identified non-matching portions of the one or more sources of data to generate the at least one new set of concepts.

3) Having constructed the knowledge categories labels, skeleton classifiers are run 230 against the input examples and the “best matches” are selected.

4) Non-matching attributes are identified 240 and the system automatically suggests variables to complete the match. Completing a match is accomplished through a series of operations that include, in some embodiments, first looking for known semantic equivalents within the input data source that could be added to the classifier in the non-matching placeholder positions. If semantic equivalents are not found within the input data, a section of the input data (that is isolated according to Syntax/Semantic Dependency rules) is pruned by applying, for example, Semantic Neutrality and the Engaged Token rules. The pruned input (e.g., the remainder of the input after the pruning operation) is inserted into the placeholders within the skeleton classifier to complete the match.

5) If syntactical constraints are unmet (i.e., they are not satisfied), the unsatisfied constraint is deactivated 250 and an additional parameter or constraint is added to the classifier to maintain complexity neutrality.

6) Finally, “sister” classifiers, based on the sister classifiers as well as other SmartSearch rules present that are related to the best matching ontology branches are added 260 to complete the constraint set for the corresponding ontology branch.

More particularly, and with continued reference to FIG. 2, to provide a new ontology (or “knowledge classification system”) for a particular subject-matter domain, an end-user (in the supervised mode), selects 210 one or more input data sources from some source corresponding to a subject matter domain with respect to which the NLP engine may not currently have an existing ontology with which to perform NLP processing (e.g., NLP processing in a manner similar to that described in, for example, the application “Management and Processing of Information”). In the non-supervised version, portions of the input data (e.g., sentences) that are likely to contain content relevant to the domain are selected using high sensitivity, low-specificity tags.

Once the example inputs have been selected, they are used to generate “labels” for the ontology nodes that accurately reflect the type of information/knowledge represented by that branch (at 220). For example, in the supervised model, the end-user writes a phrase for each knowledge category that will become its “label”. The label indicates the level of specificity or detail of the information included in the branch. For example, in situation involving input data source from a medical subject matter domain, a label might indicate that a “drug” dose should be decreased given a particular circumstance. A more specific subset of this branch might list specific drugs (indicated by an abstract placeholder for “DRUG”). In the unsupervised model, a knowledge category label is built automatically by pruning the example input, as more particularly described below, and using remaining terms to form the label.

Once input data is linked to knowledge classes in the ontology, the ML engine automatically provides the constraint sets (“hypothesis sets” or “functions”) for each corresponding ontology branch through a multi-step process. First, the complete set of skeleton classifiers is run against all identified/tagged input text, and the “best matches” are identified (at 230 of FIG. 2). Skeleton classifiers are versions of previously developed classifiers that are maintained in a format in which the constraints can be easily modified. Based on previously established/approved classifiers, the ML engine maintains a continuously updated set of “skeleton” classifiers. In some embodiments, the skeleton classifiers contain the same semantic and syntactical constraints as the previously established classifiers, but are maintained in a format in which any syntactical constraint can be deactivated, and in which each attribute may act as potential placeholders for newly identified, domain-specific tokens in the case of an attribute non-match. In other words, each attribute serves as a modifiable template or placeholder into which tokens identified within the input data source(s) are substitutable to complete an input/output match.

Each skeleton classifier has a set of “sister” classifiers which represent alternative language patterns that express the same complex concept. Sister classifiers are said to be semantically equivalent. Sister classifiers are added to the hypothesis set according to the Syntax/Semantic Dependency rules described herein. That is, based on a priori rules about interchangeable language patterns, new classifiers that are likely to be semantically equivalent are hypothesized without the need for actually locating a full complement of example input data sources.

In some embodiments, best matches are defined, based on a process that combines the number and percentage of constraints (both semantic and syntactic) that are satisfied. The process applies the skeleton classifiers to the input text to determine if the input text matches the syntactical structure of the classifiers. Determining the “best match” is a computation that, in some embodiments, takes into account the number of attributes matched and the percentage of attributes that match. In some embodiments, the matching may also be based on hierarchical weighting of syntax and semantics-based classifiers as well as part-of-speech, infection, exact term versus abstraction, and other variables/constraints/parameters within the rules sets. To evaluate the match, initially, all syntactical constraints are deactivated, and attributes are evaluated for complete matches, partial matches, and non-matches. If a syntactical non-match is concluded, the system proceeds to pinpoint the reason(s) for the lack of syntactical match (see below). If, on the other hand, there are partial or non-matching semantic attributes, the system proceeds to the next phase of “completing the semantic match.

The ML learning process involves continual analysis of input/output relationships within existing rules to identify certain types of patterns. The engine continuously updates the data base with newly approved skeleton classifiers (and their sisters). The ML learning process also tracks the addition of new semantically equivalent terms to semantic groups and automatically updates the database with newly identified secondary semantically equivalent relationships as new terms are added to individual semantic groups within classifiers. The system may keep track of all identified patterns within a relational database. The identified patterns constantly change as the system learns.

As noted, in circumstances in which the ML engine identifies partial or non-matching attributes, the system performs operation to “complete the match”. Completing the match is a multi-phase sequential process that is applied to each classifier attribute for which no input/output match is identified. To complete matches, the process relies on one or more of the inductive bias assumptions, including semantic equivalency and semantic neutrality assumptions, the token engagement assumption, the syntax/semantic dependency assumption, etc. A key aspect of the procedure used to complete attribute non-matches depends on two processes, one which involves inclusion of recognized tokens and the other which involves exclusion of unnecessary tokens.

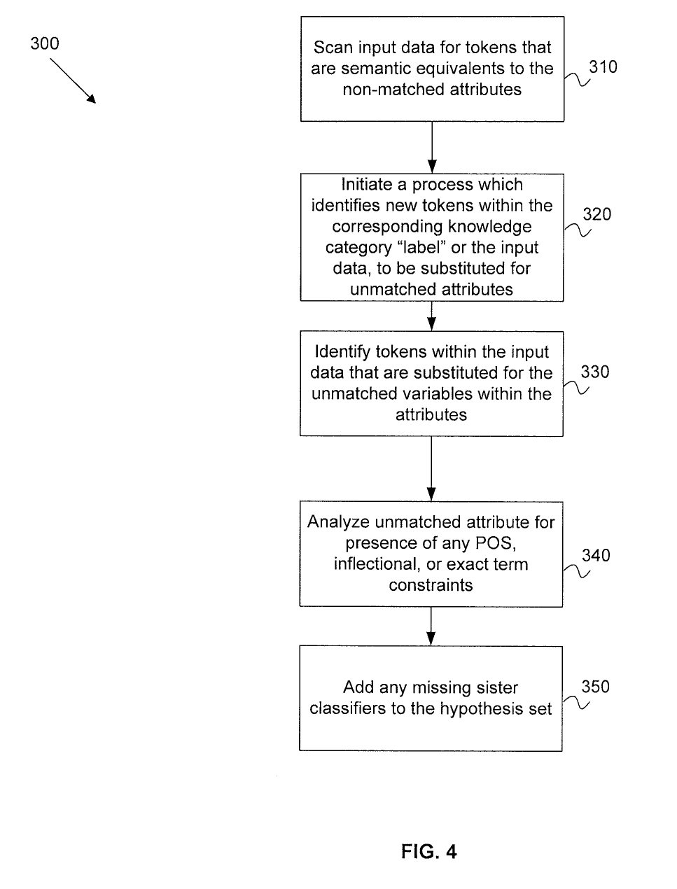

Particularly, and with reference to FIG. 4 showing a flowchart of an exemplary procedure 300 to complete attribute partial matches and mismatches, the ML engine 130 initially scans 310 input data for tokens that are semantic equivalents to the non-matched attributes. If a semantic equivalent is present, it is added as a new member of an existing semantic group or is combined with an unmatched solitary attribute of a feature group to form a new semantic group. If unmatched attributes are still present after scanning for tokens, the system initiates 320 a process which identifies new tokens within the corresponding knowledge category “label” or, alternatively, within the input data that is substituted for unmatched attributes. To accomplish this, the engine first tokenizes the knowledge category label and assesses the input data to see if any of its terms match those in the label. If a match is present, the matching token is substituted in the place of a non-matching variable within the classifier. The choice of the non-matching attribute for which the substitution should be made (if more than one non-matching attribute is present) is determined by syntactical constraints within the classifier.

If the input data and knowledge category label do not share any tokens, the system proceeds to identify 330 tokens within the input data that are substituted for the unmatched variables within the attributes. First, to identify the segment within the input data which is likely to contain the appropriate token, the engine uses syntactical constraints associated with the attribute to demarcate the input data segment that should be evaluated. Once the input data segment has been selected, it is “pruned” by removing potential tokens that are unlikely to result in a match. Tokens that are removed include those that are categorized as semantically neutral and those that are already engaged (i.e., already used). Semantically neutral tokens include modifiers that tend to modify meaning (adjectives, adverbs, timing, frequency, duration, ranges, etc), rather than radically change it. Already engaged tokens are tokens that are already used within another classifier. Tokens that remain after the pruning process are substituted in the attributes to replace unmatched variables. The engine adds the remaining tokens in positions within the classifier according to syntactical constraints present in the classifier. In addition, if the unmatched attribute is an abstract concept and a member of another abstract concept is present within the isolated string, the new abstract concept is substituted for the original. In this way, new sets of abstract concepts relevant to the new domain are substituted for those that are not pertinent within the current construct.

The unmatched attribute is analyzed 340 for the presence of any POS, inflectional, or exact term constraints. If any are present, they are tested against the newly selected tokens. If constraints are met, the system proceeds to the next operation. If the latter constraints are not met, the engine writes a sister classifier with rearranged syntax to accommodate the POS variation present within the input text. Changing the syntactical constraints (to fit the POS/inflection/etc., present in the input) may, in turn, result in the engine selecting a different input data segment from which to select a new token. For example, if a substituted constraint has an “-ed” or an “-ing” ending, the presence of this ending will be specified within the new token.

If, after matches for each attribute are accomplished, an input/output mismatch still occurs because of syntax constraints, the ML engine adds 350 any missing sister classifiers to the hypothesis set. If the input/output mismatch persists, any remaining unsatisfied syntactical constraints are disabled and, to maintain complexity neutrality, an additional attribute is added to the classifier for each constraint that is disabled. To accomplish this, the engine selects an available untagged verb within an isolated text segment and adds it to the classifier in a syntactical order that is based on its position within the text.

In addition to applying the above-described procedures for generating new classifiers, a similar process may be applied when the ML engine 130 is used to incorporate additional classifiers into an existing but incompletely developed domain. The main difference in this situation is that the process begins with an analysis that identifies the reason for a non-match. If the lack of a match is due to the application a high-level Placement Rule, the rule may be modified. If the non-match occurs because of a syntax constraint, and a matching sister classifier has not been included within the hypothesis set, the sister match is added. If a non-matching attribute(s) is at issue, the processes described above for completing a match are followed.

### Simple and Complex Concepts

Development of simple and complex concepts for the classifiers are similar in some respects. Both have ontology trees that have branches that are arranged from less to more detail (in other words, the parent branches are more generalized and the child branches are more detailed). For example, the generalized simple concept “pain” may have a child concept of “ear pain”. An example of a complex concept might be “Pain that is cause by an underlying condition” and an exemplary child concept of it might be “Pain that is caused by Rheumatoid arthritis”. The latter child concept is a specific underlying condition that can be populated into a placeholder.

An example of a complex concept ontology branch might be “Conditions that worsen over time” as a parent branch of child branches pertaining to conditions that worsen over time. The SmartSearch rule set for the latter example might be:
“CONDITION {GENERAL},increase, [MODAL ADVERB] . . . TIME”;

This SmartSearch Rule may be associated with a set of “sister SmartSearch rules” that include variation of syntax and specific semantic terms. In this example, the simple concept of “ear pain” is embedded within the complex concept (i.e., CONDITION{GENERAL} is a placeholder that will recognize “ear pain” as a simple concept).

It is to be noted that, 1) simple concepts are often used within complex concepts, 2) ML procedures to develop both simple and complex are generally the same with two exceptions, namely, a) placement rules are typically used for simple concepts but not for complex concepts, and b) the generalized ML procedure for developing new branches (and their associated SmartSearch rules) are used for both simple and complex concept development. In some embodiments, and as will become apparent below, a specialized process to develop new simple concepts based on processing standardized nomenclature systems may additionally be used.

As described herein, both simple and complex ontology branches have an associated set of processing rules, referred to as SmartSearch Rules (also referred to as forward-chaining rules or induction rules). Each ontology branch typically has more than one SmartSearch rule. These SmartSearch rules are made up of a set of both semantic and syntax constraints that, if met/satisfied by an input data sample, indicates that the input data sample contains the type of knowledge specified or indicated by the ontology branch (an example for a simple concept ontology branch might be “ear pain” which might have a set of SmartSearch rules such as, a) “discomfort . . . [prep,involving] . . . [article] . . . ear”; and b) “ear . . . discomfort”; it is to be noted that a sentence can contain both the term “ear” and “discomfort” that, when analyzed in context, are not related).

The “Placement Rules” handle the problem of identifying terms that can be considered “related” within the context of a sentence. These are rules that are applied to simple concepts (and generally not to complex concepts) to distinguish which terms within the context of a sentence are likely to be related, and therefore eligible to be used together. This is not necessary with complex concepts (as described herein in relation to the principle of “level of complexity”, the higher the complexity, the less the chance of an erroneous match).

Simple and complex concepts are also similar in that not only does each branch of a simple and complex ontology have an associated SmartSearch rule but, in addition, each branch has its own set of Exact Terms. As described herein, an Exact Term is a string that is used to match an input data exactly. Example of exact terms might be “ear pain”, “pain in the ears”, “otorrhalgia”, etc. Under some circumstances, it is helpful to have both SmartSearch rules and Exact Terms. SmartSearch rules are configured to recognize the many ways of expressing the same concept. For example, the above SmartSearch rule for “ear pain” will recognize “pain that sometimes occurs in one, but not both ears” as ear pain. The reason to use Exact Terms, in addition to SmartSearch rules (it is to be noted that exact terms are actually a subset of SmartSearch rules) is that they can match commonly used expressions and standardized nomenclature efficiently (with fast processing time).

When ML processing is used to generate new ontology branches, three components are generally created: the branch name or “label”, the associated SmartSearch rule set, and the associated Exact Terms. These components may be generated for both simple and complex concepts. In the “assisted” process, the developer starts by creating the ontology branch label (typically the first level only, because subsequent levels or “child” branches can be constructed/generated automatically by attaching modifiers (e.g., “pain” versus “ear pain”, or “Symptoms that worsen over time” versus “Specific symptoms that worsen over time”). Once the label is created, it is tested against a set of “skeleton rules”. Such skeleton rules are based on a collection of all SmartSearch rules for all existing ontology branches. The skeleton rules differ from the SmartSearch rules mostly in that they have been configured (e.g., via rule programming) to have different functional capabilities. Particularly, they are configured so that they are able to indicate which of their “constraints”/“instructions” are met and which are not. With reference to the ear pain example used above, the term “ear” might match while “discomfort” might not match the input data. Alternatively, both ear and pain might match, but the order might not match the syntax specified in the SmartSearch rule. The skeleton rules are thus provided to first identify which of the constraints match (first semantic

and then syntax constraints) and which do not. Second, the skeleton rules are configured so that (if they are among the “best matches”) they have the flexibility to substitute the appropriate portions of the input data into their own structure in the location of the non-matching constraint. Once the substitutions are made, the skeleton rules become “SmartSearch” rules for the new ontology branch. It is to be noted that if we are creating new ontology branches, the text that is tested against the skeleton rules is actually the ontology label.

Another way to construct/generate new ontology branches (either for an existing domain or for a new domain) is to submit source data to be tested against the SmartSearch rules (this is in contrast to submitting the label as the “source date”). If the match is close enough, the new SmartSearch rule becomes a member of the existing ontology branch to which the skeleton rule originally belonged. On the other hand, if the match is not close enough, the source data will be used to generate a new ontology label and will be modified (e.g., “ear,pain” or “pain . . . [PREP] . . . ear” rather than “ear pain”) to create a new set of SmartSearch rules for this new label.

New ontology branches can be generated using the above-described methodology. For already existing ontology branches, new SmartSearch rules can be created for a branch by slightly varying the above process. Rather than using label of the ontology branch for the substitutions into the skeleton rules, new SmartSearch rules for existing branches are created by submitting input data (e.g., input text) from selected source material (from the medical literature, for example). Once the “best matching” skeletal rules have been identified, the skeletal rule can be altered with substitutions to the mismatched portions/constraints. In this case, rather than creating a new ontology branch, new SmartSearch rules are added to the existing ontology branch to which the original skeletal rule is a member. Under these circumstances, the skeletal rules look a lot like the original SmartSearch rules upon which they were based and the system keeps track of the ontology branches to which they belong. Furthermore, the decision about whether a new branch should be defined versus adding a new SmartSearch rule to an existing branch depends on the closeness of match between the input data and the SmartSearch rule constraints.

As noted the above, the methodologies used with respect to the simple and complex concepts (e.g., generating new ontologies, generating new SmartSearch Rules) apply to both simple and complex concepts, with the exception that “Placement Rules” are generally applied only to the simple concepts.

As described herein, simple concepts are typically the building blocks of a domain. For example, for healthcare such simple concepts could include symptoms, conditions, treatments, procedures, lab tests, medications, etc, and there are often standard nomenclature systems within a domain that identify these types of basic concepts (e.g., ICD 9 database terms that lists medical conditions such diseases, etc., might include “Congestive heart failure”, while the UMLS database might use the term “Heart Failure”). Although these standardized terms cannot be used alone to process free data (e.g., free text) because they are too limiting, the terms can nevertheless be used to efficiently construct/generate new SmartSearch rules that, in turn, can be used to process free input data.

As described herein, to take advantage of standardized nomenclature systems to create simple concepts, an additional process may be used to access standardized nomenclature systems (such as ICD 9, UMLS, etc.) and import sets of standardize terminology to generate new ontology branches and their corresponding SmartSearch rules and Exact Terms. This methodology uses the standardized nomenclatures sources almost like other free text (or other data sources) are used, but with a few twists. Basically, the standardize nomenclature terms are received and pruned, with the resultant non-discarded terms being used to create labels, and subsequently create SmartSearch rules using the procedures described herein.

Thus, two methodologies may be used to create simple concepts: the specialized methodology based on use of standardized nomenclature and the generalized methodology that is also used to create complex concepts. In the above heart failure example with the long string of text, the generalized method is used to create a SmartSearch rule that recognizes “heart failure” within the string. A SmartSearch rule created with the generalized methodology may look somewhat different from the ones generated using the standardized nomenclature.

According, as described in some embodiments, operations dedicated to processing or otherwise handling simple concepts are performed. Simple concepts represent a special subcategory of information that requires modification of the ML process. Simple concepts typically represent the basic units of information that are specific to a domain (for example, in a medical subject matter domain, simple concepts may include symptoms, procedures, treatments, laboratory tests, etc.). Lists of these basic concepts are often available within standardized nomenclature sources (e.g. UMLS, SNOWMED, CPT, etc). These sources, however, tend to cover a limited range of the many and varied regular expression terms/phrases that are used to express the concepts. The ML engine 130 addresses this problem by reconfiguring the standardized nomenclature lists to build hypothesis sets that will, in turn, recognize a full complement of the regular expressions that are used to express these concepts. The reconfigured standardized nomenclature classifiers are referred to as SmartSearch terms. Since the SmartSearch classifiers for Simple Concepts generally contain fewer than three parameters/constraints (feature factors), Placement Rules have been developed to improve consistency. These high-level rules may be applied to all Simple Concepts.

In some embodiments, the system 100 uses several approaches to identify the presence of unmatched Simple Concepts within input data. First, the system uses the presence of high-level tokens (high sensitivity/low specificity) to tag sentences as being likely to include certain simple concepts. Sentences with these tags that do not produce a match (e.g., a match corresponding to an instruction/parameter/constraint of a SmartSearch Rule) are first isolated for further analysis. Next, the sentence is “pruned” (e.g., “Text Pruning”) by eliminating semantically neutral tokens and finally by eliminating tokens that are engaged. The remaining untagged text is submitted as a hypothesis for either a new simple concept or as a synonym for an existing simple concept.

A second approach used to identify unmatched simple concepts is based on assumptions that a contiguous set of terms within an input data source is identified as related according to the arrangement or ordering of the phrases (syntax) as well as according to the semantic context in which these words occur within the sentence. To identify the unmatched simple concept based on this approach, a set of “Connector Rules” which have a format similar to Placement Rules, that are to indicate the likely presence of a list or string of related simple concepts may be used. Any unmatched tokens within the defined borders of an input data segment that are not eliminated as semantically neutral or engaged are submitted as a hypothesis for either a new simple concept or as a synonym for an existing simple concept.

In addition, because simple concepts often appear as contiguous terms, the system is configured to recognize two or more untagged terms within a contiguous string of simple concepts as potentially unrecognized simple concepts. The ML engine analyzes these untagged strings for inclusion after excluding semantically neutral tokens and engaged tokens.

The system described herein may further be configured to produce generalized parent categories. Particularly, the presence of a general term, such as “medication” rather than the specific medication name (e.g., when processing input data pertaining to medical subject matter domain), should generally be covered by a parent category. The ML engine is configured to analyze and keep track of all parent categories in which particular abstract concepts have been generalized. If an abstract concept non-match is identified, the system will search for terms that have been substituted within other parent categories. If an unmatched portion of the string contains this term or a related term, the system will include it within a new parent classifier. The new term will be placed in an order within the function that had been specified for the original non-matched abstract concept. If no order had been specified within the original target function, syntactical constraints are considered unnecessary within the new parent.

The data used by the ML engine 130 includes, for example, members of semantic groups, possible tokens pairs within a semantic group, semantic group members that have secondary relationships to other semantic groups because they share a member (e.g., if A, and B are members of Group one, B and D are members of Group two, then A is therefore “semantically related” to D) may be stored on a ML database that is managed and/or accessed by the ML engine.

When used to extend NLP capabilities to new domains, the ML engine re-uses basic lexicons of synonyms, idioms, modifiers (severity, quality, location, changes of the above over time), measurement descriptors (of time, frequency, percentage, distance, number, range, etc.), as well as domain-specific lexicons (e.g., for the healthcare, such lexicons may include symptoms, treatments, tests, anatomy, demographics, pathology, pathophysiology, physical findings, etc.) that were defined or added when initial ontologies were being generated. These Simple Concepts are incorporated into the Compound Concepts of the new ontology. Particularly, the simple concepts are used to define new simple concepts within the simple concept set. In Addition, if the context within which these simple concepts exist within the input text has enough of a match with a complex concept, then they will be submitted for matching tests with complex concepts as well.

To generate new sets of concepts (e.g., new ontologies) and/or perform NLP processing for various subject matter domains, in some embodiments, hypothesis sets of simple concepts that include the nomenclature (or vocabulary) of common terms used in relation to those various subject matter domains are generated.

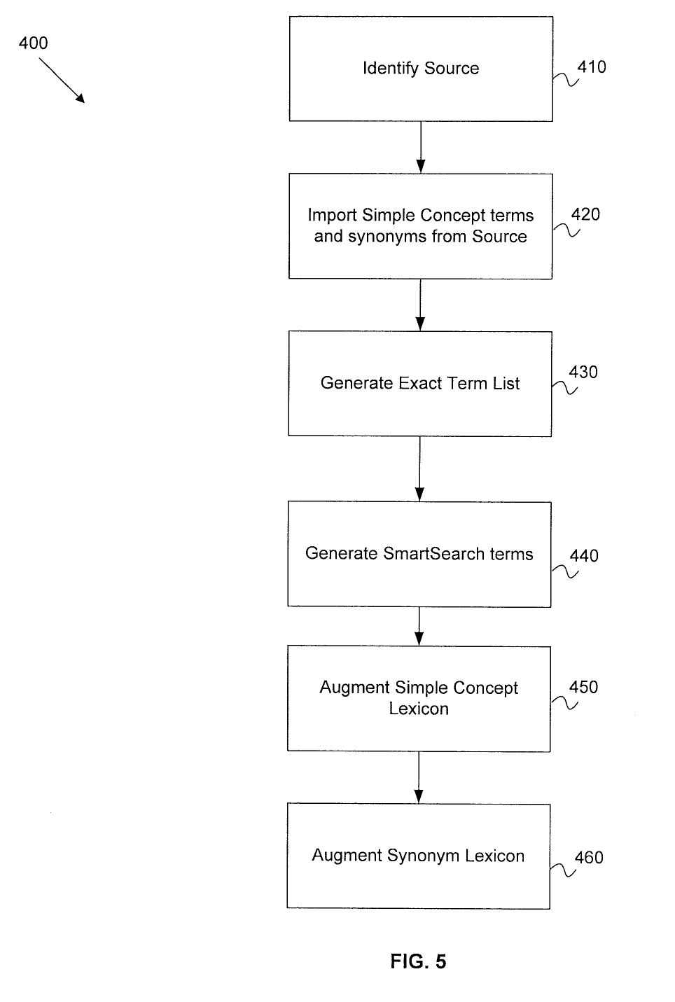

Referring to FIG. 5, a flow chart of an exemplary procedure 400 to generate hypotheses sets (simple concepts sets) is shown. Initially, a source having a defined set of simple concepts vocabulary for a particular subject matter domain is identified 410 and/or accessed. For example, for a medical subject matter domain, sources that include lists of common terms and concepts may be found on the Unified Medical Language System (UMLS) or on the Current Procedural Terminology (CPT) system which includes a database of health and medical information. Having identified and/or accessed a source having lists of common terms/concept and any specialized vernacular for the particular subject matter, the list of terms and concept for the particular subject matter domain is/are imported 420 to the system 100. For example, in relation to the medical subject matter domain, lists of drug names, procedure and procedure types may be imported from such sources as UMLS and CPT.

Subsequently, using, at least in part, the imported lists of terms/concepts for the particular subject matter domain, an exact term list is generated 430. Exact terms are conceptual attributes for which there may be no substitutions, and may include specific terms that also represents synonyms, an abstract placeholder for any number of specific terms, or a group of terms.

After generating the list of exact terms, the “SmartSearch” rules are generated 440. As noted, the SmartSearch terms are forward-chaining logical rule associated with a concept. These SmartSearch terms are the parameters/constraints sets and sister rules that are matched against the input data to see if the ontology branch is invoked/met. The SmartSearch rules then become the basis for the “skeletal” rules which can be manipulated with substitutions to form new constraint sets for new ontology branches. To generate the SmartSearch Terms, in some embodiments, the terms in the Exact Terms list (e.g., obtained from standardized nomenclature found in data sources corresponding to various subject domain, for example, UMLS sources for the medical domain) are pruned to remove semantically neutral terms (such as modifiers). The remaining terms in the list (i.e., after the pruning) are converted to root form, and preposition and verb inflection rules are applied to them to distill the terms into a normalized format that can be subsequently used in the course of NLP processing and/or to generate new SmartSearch rules for simple concept ontologies. Lastly, Placement Rules are applied to the resultant normalized terms. The Placement rules are applied to make sure that the terms that are submitted together are eligible, according to the placement rules, to be used/submitted as a unit. If the input standardized nomenclature contains extraneous text, (for example, ICD 9 might say state something like, angioplasty with stents—in the left anterior descending artery rather than the RCA) portions of it may be excluded because these portions are not eligible for inclusion according to placement rules.

Additionally, in developing the simple concepts, the simple concept lexicon is augmented 450. Particularly, a list of high sensitivity/low specificity tags is generated (the list used to perform the initial scan of a data source to recognized simple matches between the tags and the content of the data source). Sentences of the input data that do not contain a Simple Concept are then identified with these tags. The tagged sentences are then examined to determine whether simple concepts are present. Any identified simple concepts are added to the Exact Term lexicon (manual) and Smart-Search terms are generated.

Particularly, simple context-containing string in the input data are identified and then pruned. The pruned portions are converted to root form and distilled into a normalized form to transform them into new SmartSearch rules. Once the SmartSearch rules are formed, “exact terms” are generated (e.g., an exact term corresponding to the SmartSearch Rule containing the parameter “heart,failure,congenital” may be “congenital heart failure”). The SmartSearch rule can recognize all sorts of ways of saying congenital heart failure such as “heart failure—congenital” or “congestive failure that occurs at birth”, etc., whereas the exact term “congenital heart failure” only recognizes the exact string match. However, use of the exact term has the advantage of processing efficiency, and thus is kept on the list. Another reason to maintain the exact term list is that it matches the standardized nomenclature terms exactly.

As further shown in FIG. 5, the generation of a simple concept set further includes augmenting 460 the synonym lexicon. In particular, exact terms which do not have associated synonyms are identified. Synonyms for the exact terms thus identified from the source (e.g., UMLS and/or CPT, etc.) are imported. The imported synonyms are labeled according to categories of “common language”, “technical” language (e.g., medical terminology), and/or a specific language (English, Spanish, etc.).

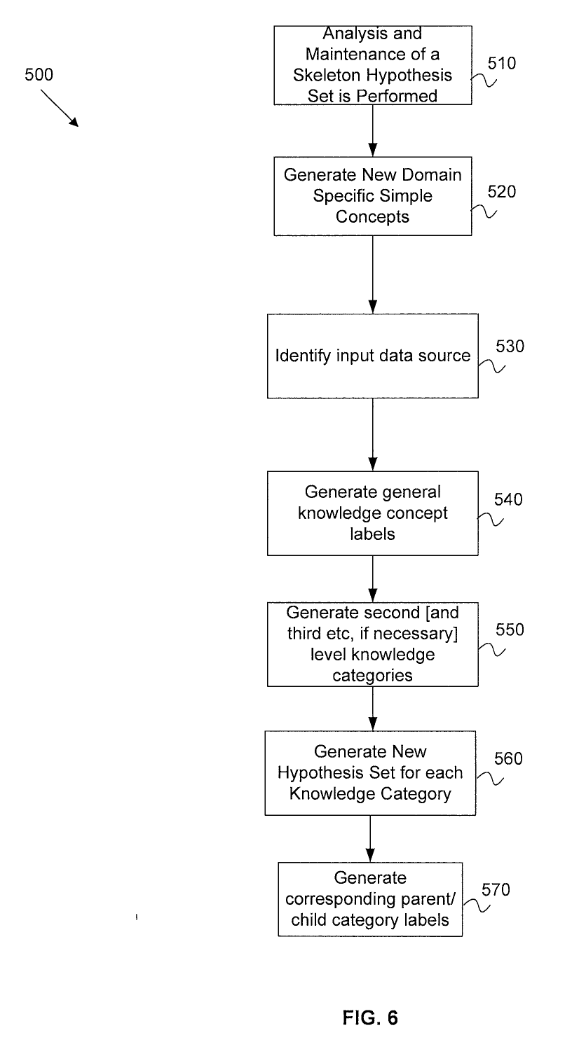

In addition to generating a simple concept set (e.g., in the manner depicted in FIG. 5), in some embodiments, the system 100 is also configured to generate complex concepts sets (i.e., combinations of main and subsidiary ideas that may be compounded and may include simple concepts). Referring to FIG. 6, a flowchart of an exemplary procedure 500 to generate a complex concept set is shown. At 510, analysis and maintenance of a skeleton hypothesis set. Skeleton hypothesis sets are maintained with placeholders into which domain-specific abstract Simple Concepts can be substituted. The skeleton hypothesis sets are analyzed for existing input/output relationships to identify semantic equivalents (primary and secondary). A list of all semantically neutral tokens (those determined and those that are to be determined) is also maintained.

The SmartSearch rules form the basis of the skeletal hypothesis set. It is to be noted that both simple and complex concepts have SmartSearch rules, but the new simple concepts and the new complex concepts are generated, in some embodiments, using different approaches. It is also to be noted that new simple concept generation identified above does not use SmartSearch skeletal rules. In contrast, skeletal rules that are derived from the SmartSearch rules of complex concepts are used as the basis for new complex concepts. Generally, these complex concept skeletons have placeholders in which to incorporate domain-specific simple concepts

As further shown in FIG. 6, a new domain-specific simple concepts set is generated 520 for the particular domain with respect to which the complex concept set is to be generated/developed. Generating the simple concept set may be performed, for example, in a manner similar to that described in relation to FIG. 5.

At 530, input data source that is to be used to generate the complex concept set is identified, accessed and received.

Having received the input data source(s), a new general (i.e., first-level “parent”) knowledge concept labels for the ontology (being generated or updated) is constructed/generated 540. The first level knowledge labels can apply to both simple and complex concepts. First level knowledge labels refer to “parent” ontology levels. Because the ontology branches in the systems described herein move from the more generalized to the more specific (e.g., “medication” versus “amoxicillin” or “years” versus “3-6 years”, etc), the first level/or parent branches are more generalized whereas the child branches have increasing levels of detail.

Having constructed the first level concept labels, a new second level (and/or a third and additional level, if appropriate) knowledge categories for the ontology are constructed or generated. Specifically, high-level domain-specific tags are used to isolate relevant data segments (e.g., sentences) within the received input data source(s). Ontology branches are constructed by labeling the type of knowledge found in tagged text (e.g., drugs which should not be taken together). Tagged data (text) is then assigned to corresponding knowledge category. Such an assignment may be, in some embodiments, performed manually for the first one or two iterations. Subsequently, the more specific child/branches are constructed.

Next, a new hypothesis set similar to the “SmartSearch rules” is constructed (or generated) 560 for each knowledge category. Specifically, the input data source(s) is tagged, for example, for simple concepts, known semantic equivalents, modifiers, matching complex concepts, idioms, exclusions (global and rule-based). All terms in the ontology label are then tagged and semantically neutral tokens are removed. Skeleton hypothesis set are then applied against the input data source(s). Appropriate abstract simple concepts are then substituted into placeholders, and syntactical constraints are all disabled. Particularly, the syntactical constrains are disabled initially to enable semantic matching to be tested first. If there is a match, then the syntax constraints may be applied. If the semantic constraints do not match, the system generates “sister” SmartSearch rules, based on all possible allowable syntax configurations, to determine if any of these would apply. If one or more applies, then a new rule is created and the POS/inflection stipulations that are a given for the particular sister configuration are used for this rule.

Next, the best matched skeleton classifiers are identified. To identify the best matched skeleton classifier, “best match” calculations to determine the suitability of the various classifiers are performed.

Having identified the optimal skeleton classifier to use, the partial matches with respect to the input data source(s) may be completed. To that end, non-matching attributes are completed (in the manner described herein with respect to FIG. 3). In some embodiments, completing the non-matching attributes may be performed by identifying non-matching attributes, and determining the reasons for the non-matches identified (syntactical or unmatched token). If the reason that a non-matching attribute has been identified is that there is a missing or unmatched token(s), the input data source is searched for semantic equivalents. Under those circumstances, if semantic equivalents are present, these are added, either as a new member of a semantic group, or as a newly constructed semantic group that includes the unmatched attribute and its semantic equivalent(s).

If, on the other hand, a semantic equivalent is not present, the identified new token is added in the corresponding ontology label if it is also present in input data source. Particularly, the new ontology label token is positioned within the classifier according to “Attribute Syntax Assignment” rules.

If there are no ontology label tokens present in example input data, untagged terms from the example input data are added (after semantically neutral terms and engaged terms have been excluded). Specifically, the untagged terms are positioned within the classifier according to “Attribute Syntax Assignment” rules.

With continued reference to FIG. 6, corresponding parent/child category labels are constructed/generated 570. Specifically, terms that represent category names for members of abstract concepts (e.g., penicillin and Tylenol belong to “medication”, or “drug” categories) are identified. Using these identified terms, more generalize parent categories for the ontology are generated. The corresponding general category names are substituted for the abstract concept placeholder within the function(s). Additionally, more detailed “child” categories for the ontology are generated, and the corresponding abstract concept placeholders are substituted for the more general category names within the function(s).

Subsequently, the syntax rules are reactivated. If the reactivation results in a non-match, the offending syntactical constraint causing the non-match is disabled and one untagged token (preferably a verb) is added for every constraint disabled. To identify new token within ontology labels, semantically neutral tokens, engaged tokens, modifiers and/or exclusions are removed from the label. The remaining tokens are stored as a list of terms relevant to domain (domain-specific tokens). Additionally, domain-specific tokens that are members of abstract concept groups are identified. Synonyms for new terms that do not have previously assigned synonyms are imported.

To illustrate the operation of the procedures to generate new sets of concepts (e.g., new ontologies), consider an example in which an existing complex concept is “Conditions required for ?(SPECIFIC) study enrollment”. This complex concept has a subset of SmartSearch rules that includes the following four SmartSearch Rules:

1) in...study...[of,with,involve]...[patient,women,men,children]...
with...CONDITION(GENERAL)...[cause,develop,report,incidence
,prevalence]...no...effect;
2) study...patient...[treat,treatment]...[of,for]...NOT
[experience,found,develop,suffer,may,had]...
CONDITION(GENERAL);
3) study...[of,with,involve]...NOT
experience...CONDITION(GENERAL)...NOT
guaiac...[find,reveal,demonstrate,experience]...SIDE EFFECT;
4) NUMBER percent of...?SPECIFIC
study,[patients,population]...[have,consist]...
CONDITION(GENERAL)

In this example, the following new input data sample is received:
“Seventy-five percent of the students who were eligible for the early admissions program had a grade point average of 3.5”

The new input data, which that does not match any of the existing SmartSearch rules, is submitted to the system for processing,

The “best” partial SmartSearch match for this sample (as determined from computations to determine the optimal SmartSearch Rule suitable for parsing the received input data) is determined to be:

NUMBER percent of...?SPECIFIC
study,[patients,population]...[have,consist]...
CONDITION(GENERAL)

The resultant matches for this SmartSearch Rule are shown below, with the non-matching substitutions appearing in italics:

[NUMBER percent of] {Seventy-five percent of}...[?SPECIFIC]
{early admission} [study] {program},[patients,population]
{student}...[have,consist] {who_were,eligible}...[CONDITION]
{grade point average}

Under these circumstances, the new concept title, or label, would be “Conditions required for ?(SPECIFIC) program enrollment”. The variable that would be populated into the CONDITION category would be “grade point average”. The variable for ?SPECIFIC would be early admission.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A method to generate at least one new set of concepts to be used to perform natural language processing (NLP) on data, the method comprising:
receiving one or more sources of input data; and
determining, based on the one or more sources of input data and on at least one initial set of concepts, at least one attribute representative of a type of information detail to be included in the at least one new set of concepts.

2. The method of claim 1 wherein determining, based on the one or more sources of input data and on at least one initial set of concepts, at least one attribute representative of a type of information detail to be included in the new set of concepts comprises:
comparing attributes of the at least one initial set of concepts to the one or more sources of input data to identify non-matching attributes of the at least one initial set of concepts that do not match any portion of the one or more sources of input data.

3. The method of claim 2 wherein the non-matching attributes of the at least one initial set of concepts includes attributes that do not semantically or syntactically match any portion of the one or more sources of input data.

4. The method of claim 2 further comprising:
identifying non-matching portions of the one or more sources of data that do not match any of the attributes of the at least one initial set of concepts; and
replacing the identified non-matching attributes of the at least one initial set of concepts with the identified non-matching portions of the one or more sources of data to generate the at least one new set of concepts.

5. The method of claim 4 wherein identifying non-matching portions of the one or more sources of data comprises:
removing from the one or more sources of data one or more of: matching portions that match at least one attribute of the at least one initial set of concepts and semantically neutral portions of the one or more sources of data.

6. The method of claim 1 further comprising:
generating one or more processing rules having one or more search constraints, the one or more processing rules adapted to be applied to input data, the one or more processing rules being associated with the determined at least one attribute representative of the type of information detail to be included in the new set of concepts.

7. The method of claim 6 wherein the one or more processing rules are each associated with one or more groups corresponding to respective levels of rule complexity, wherein at least one group of rules associated with a first level of complexity is a subset of another group of rules associated with another, higher, level of rule complexity.

8. The method of claim 1 further comprising:
identifying from an initial set of processing rules one or more processing rules that produce close matches with the one or more sources of data, each of the processing rules of the initial set including one or more searching constraints; and
modifying at least one of the one or more searching constraints of the identified processing rules.

9. The method of claim 1 wherein determining the at least one attribute representative of the type of information detail to be included in the new set of concepts comprises:
determining the at least one attribute representative of the type of information detail based on one or more inductive bias assumptions.

10. The method of claim 9 wherein the one or more inductive bias assumptions include one or more of: an assumption that consistency and accuracy of a classification operations applied to the one or more sources of input data increases with increased complexity of processing rules applied to the one or more sources of input data, an assumption of maintaining complexity neutrality, an assumption that semantically related terms are interchangeable, an assumption that concept modifiers do not alter the semantic content of a concept, an assumption that a portion within the one or more sources of data input assigned to a function is not available to be assigned to another function and an assumption that syntax and the choice of semantic expression used in the at least one set of concepts are dependent.

11. The method of claim 9 wherein the one or more inductive bias assumptions comprise forward-chaining rules that specify allowable combinations of data portions within the received one or more sources of input data.

12. The method of claim 9 wherein determining the at least one attribute representative of the type of information detail based on one or more inductive bias assumptions comprises:
determining the at least one attribute representative of the type of information detail based on one or more inductive bias assumptions that process the one or more source of input data in a manner that simulates an operation of human knowledge acquisition and storage.

13. The method of claim 1 wherein the at least one initial set of concepts includes a continuously updated set of skeleton classifiers.

14. The method of claim 13 wherein the skeleton classifiers include skeleton ontologies.

15. The method of claim 1 further comprising:
determining from the at least one initial set of concepts an optimal set of concepts to apply to the one or more sources of data input to generate the new set of concepts.

16. The method of claim 1 further comprising:
importing simple concept terms and synonyms from a remote source maintaining lists of simple concept terms;
constructing an exact term list from the imported concept terms and synonyms; and
generating for the at least one new set of concepts processing rules having search constraints by removing semantically neutral terms in the exact terms list and converting terms remaining in the exact term list to a normalized format.

17. The method of claim 16 further comprising:
augmenting a simple concept lexicon.

18. The method of claim 16 wherein generating processing rules comprises:
applying preposition and verb inflection rules and Placement Rules.

19. The method of claim 1 further comprising constructing a database for the at least one initial set of concepts.

20. The method of claim 19 wherein constructing the database for the at least one initial set of concepts comprises:
forming complex concept terms from an identified remote source of input data.

21. An apparatus, comprising:
a computer system including a processor and memory; and
a computer readable medium storing instructions for natural machine learning (ML) processing including instructions to cause the computer system to:
receive one or more sources of input data; and
determine, based on the one or more sources of input data and on at least one initial set of concepts, at least one attribute representative of a type of information detail to be included in the at least one new set of concepts.

22. The apparatus of claim 21 wherein the instructions that cause the computer system to determine, based on the one or more sources of input data and on at least one initial set of concepts, at least one attribute representative of a type of information detail to be included in the new set of concepts comprise instructions that cause the computer system to:
compare attributes of the at least one initial set of concepts to the one or more sources of input data to identify non-matching attributes of the at least one initial set of concepts that do not match any portion of the one or more sources of input data.

23. The apparatus of claim 22 wherein the non-matching attributes of the at least one initial set of concepts includes attributes that do not semantically or syntactically match any portion of the one or more sources of input data.

24. The apparatus of claim 22 wherein the instructions further comprise instructions that cause the computer system to:
identify non-matching portions of the one or more sources of data that do not match any of the attributes of the at least one initial set of concepts; and
replace the identified non-matching attributes of the at least one initial set of concepts with the identified non-matching portions of the one or more sources of data to generate the at least one new set of concepts.

25. The apparatus of claim 24 wherein the instructions that cause the computer system to identify non-matching portions of the one or more sources of data comprise instructions that cause the computer system to:
remove from the one or more sources of data one or more of: matching portions that match at least one attribute of the at least one initial set of concepts and semantically neutral portions of the one or more sources of data.

26. The apparatus of claim 21 wherein the instructions further comprise instructions that cause the computer system to:
generate one or more processing rules having one or more search constraints, the one or more processing rules adapted to be applied to input data, the one or more processing rules being associated with the determined at least one attribute representative of the type of information detail to be included in the new set of concepts.

27. The apparatus of claim 21 wherein the instructions further comprise instructions that cause the computer system to:
identify from an initial set of processing rules one or more processing rules that produce close matches with the one or more sources of data, each of the processing rules of the initial set including one or more searching constraints; and
modify at least one of the one or more searching constraints of the identified processing rules.

28. The apparatus of claim 21 wherein the computer instructions that cause the computer system to determine the at least one attribute representative of the type of information detail to be included in the new set of concepts comprise instructions that cause the computer system to:
determine the at least one attribute representative of the type of information detail based on one or more inductive bias assumptions.

29. The apparatus of claim 28 wherein the one or more inductive bias assumptions include one or more of: an assumption that consistency and accuracy of a classification operations applied to the one or more sources of input data increases with increased complexity of processing rules applied to the one or more sources of input data, an assumption of maintaining complexity neutrality, an assumption that semantically related terms are interchangeable, an assumption that concept modifiers do not alter the semantic content of a concept, an assumption that a portion within the one or more sources of data input assigned to a function is not available to be assigned to another function and an assumption that syntax and the choice of semantic expression used in the at least one set of concepts are dependent.

30. The apparatus of claim 21 wherein the at least one initial set of concepts includes a continuously updated set of skeleton classifiers.

31. The apparatus of claim 30 wherein the skeleton classifiers include skeleton ontologies.

32. The apparatus of claim 21 wherein the instructions further comprise instructions to cause the computer system to:
determine from the at least one initial set of concepts an optimal set of concepts to apply to the one or more sources of data input to generate the new set of concepts.

33. The apparatus of claim 21 wherein the instructions further comprise instructions to cause the computer system to:
import simple concept terms and synonyms from a remote source maintaining lists of simple concept terms;
construct an exact term list from the imported concept terms and synonyms; and
generate for the at least one new set of concepts processing rules having search constraints by removing semantically neutral terms in the exact terms list and converting terms remaining in the exact term list to a normalized format.

34. A computer program product residing on a computer readable medium for machine learning (ML) processing, the computer program product comprising instructions to cause a computer to:
receive one or more sources of input data; and
determine, based on the one or more sources of input data and on at least one initial set of concepts, at least one attribute representative of a type of information detail to be included in the at least one new set of concepts.

35. The computer program product of claim 34 wherein the instructions that cause the computer to determine, based on the one or more sources of input data and on at least one initial set of concepts, at least one attribute representative of a type of information detail to be included in the new set of concepts comprise instructions that cause the computer to:
compare attributes of the at least one initial set of concepts to the one or more sources of input data to identify non-matching attributes of the at least one initial set of concepts that do not match any portion of the one or more sources of input data.

36. The computer program product of claim 35 wherein the non-matching attributes of the at least one initial set of concepts includes attributes that do not semantically or syntactically match any portion of the one or more sources of input data.

37. The computer program product of claim 35 wherein the instructions further comprise instructions that cause the computer to:
identify non-matching portions of the one or more sources of data that do not match any of the attributes of the at least one initial set of concepts; and
replace the identified non-matching attributes of the at least one initial set of concepts with the identified non-matching portions of the one or more sources of data to generate the at least one new set of concepts.

38. The computer program product of claim 37 wherein the instructions that cause the computer to identify non-matching portions of the one or more sources of data comprise instructions that cause the computer to:
remove from the one or more sources of data one or more of: matching portions that match at least one attribute of the at least one initial set of concepts and semantically neutral portions of the one or more sources of data.

39. The computer program product of claim 34 wherein the instructions further comprise instructions that cause the computer to:
generate one or more processing rules having one or more search constraints, the one or more processing rules adapted to be applied to input data, the one or more processing rules being associated with the determined at least one attribute representative of the type of information detail to be included in the new set of concepts.

40. The computer program product of claim 34 wherein the instructions further comprise instructions that cause the computer to:
identify from an initial set of processing rules one or more processing rules that produce close matches with the one or more sources of data, each of the processing rules of the initial set including one or more searching constraints; and
modify at least one of the one or more searching constraints of the identified processing rules.

41. The computer program product of claim 34 wherein the computer instructions that cause the computer to determine the at least one attribute representative of the type of information detail to be included in the new set of concepts comprise instructions that cause the computer to:
determine the at least one attribute representative of the type of information detail based on one or more inductive bias assumptions.

42. The computer program product of claim 41 wherein the one or more inductive bias assumptions include one or more of: an assumption that consistency and accuracy of a classification operations applied to the one or more sources of input data increases with increased complexity of processing rules applied to the one or more sources of input data, an assumption of maintaining complexity neutrality, an assumption that semantically related terms are interchangeable, an assumption that concept modifiers do not alter the semantic content of a concept, an assumption that a portion within the one or more sources of data input assigned to a function is not available to be assigned to another function and an assumption that syntax and the choice of semantic expression used in the at least one set of concepts are dependent.

43. The computer program product of claim 34 wherein the at least one initial set of concepts includes a continuously updated set of skeleton classifiers.

44. The computer program product of claim 43 wherein the skeleton classifiers include skeleton ontologies.

45. The computer program product of claim 34 wherein the instructions further comprise instructions to cause the computer to:
determine from the at least one initial set of concepts an optimal set of concepts to apply to the one or more sources of data input to generate the new set of concepts.

46. The computer program product of claim 34 wherein the instructions further comprise instructions to cause the computer to:
import simple concept terms and synonyms from a remote source maintaining lists of simple concept terms;
construct an exact term list from the imported concept terms and synonyms; and
generate for the at least one new set of concepts processing rules having search constraints by removing semantically neutral terms in the exact terms list and converting terms remaining in the exact term list to a normalized format.
